(19) United States
(12) Patent Application Publication
(10) Pub. No.: US 2019/0209275 A1
(43) Pub. Date: Jul. 11, 2019

(54) CERAMIC SHELL FOR PRODUCING A DENTAL PROSTHESIS AND METHOD FOR PRODUCING A CERAMIC SHELL FOR A DENTAL PROSTHESIS

(71) Applicant: bredent GmbH & Co. KG, Senden (DE)

(72) Inventor: Joachim MEYER, Ulm (DE)

(73) Assignee: bredent GmbH & Co. KG, Senden (DE)

(21) Appl. No.: 16/303,316

(22) PCT Filed: May 23, 2017
(86) PCT No.: PCT/EP2017/062467

§ 371 Date: Nov. 20, 2018

(30) Foreign Application Priority Data
May 23, 2016 (DE) 10 2016 109 447.1

(51) Int. Cl. A61C 13/00; A61C 5/20

(52) U.S. Cl. CPC A61C 13/0022; A61C 5/77; A61C 13/0006; A61C 5/20

(57) ABSTRACT

A ceramic shell for producing a dental prosthesis, particularly for veneering a dental scaffold or as a full ceramic dental prosthesis, is produced by a method wherein the ceramic shell is manufactured in the form of a green compact from a ceramic powder and a binder system such that the ceramic shell can be shaped flexibly and can be adjusted plastically to adapt to a body.

The invention relates to a ceramic shell for the production of a dental prosthesis as well as to a method for the production of a ceramic shell for a dental prosthesis, in particular for veneering of a dental framework or as a full ceramic dental prosthesis.

Use of ceramic materials in dental technology is widespread. Aside from use in prosthetics, such as, for example, individual crowns, veneer shells (called veneers), for example, are also produced from ceramics.

A ceramic dental prosthesis and a method for its production are known from WO 2007/028 787 A1. In this document, a dental prosthesis is described, in particular in the form of a composite crown or a composite bridge, which prosthesis consists of two independent components, which are configured as an inner framework structure and an outer veneer sheath, which are connected with one another by means of a connector compound. In this regard, the connector compound is liquid or at least viscous at room temperature, so as to simplify processing.

A method for the production of a functional dental element is known from DE 600 23 315 T2, in which method layers composed of a suitable ceramic material, which is a powder, are applied one after the other. In this regard, a binder is applied to each layer composed of powder at desired positions, by means of three-dimensional printing technology, so as to bind each layer composed of powder to the preceding layer, thereby allowing removal of excess, non-adhering powder. Subsequently, the dental element produced in this way is subjected to a sintering step, and the sintered element is infiltrated by a second phase. A debonding step can also follow the sintering step.

An adhesion-imparting agent between an oxide ceramic and a veneer material, in particular for dental purposes, is known from DE 10 2009 051 593 A1. In this regard, an adhesion-imparting agent in the form of a mixture of silicate ceramic and quartz is applied as a sol to a base body composed of an oxide ceramic or its starting materials, which body is to be veneered and has not yet been hard-sintered. Subsequently, the base body, with the adhesion-imparting agent worked into it, is completely sintered and afterward the veneer material is applied. In this way, dental crowns or bridges that can withstand great stress can be produced.

A green-ceramic tape is described in US 2004/0245663, which tape can be used for the production of dental restorations. For this purpose, the tape is laid around a model of a tooth stump and subsequently adjusted and fired.

A method for the production of a dental prosthesis is known from U.S. Pat. No. 5,346,397 A, in which method a ceramic shell that has not yet been adjusted and fired is used together with a ceramic paste as a buildup material, so that a dental prosthesis that matches in terms of color and shape but has not yet been fired is formed.

In EP 0 826 642 A2, the production of a ceramic dental prosthesis crown or of a ceramic dental prosthesis shell is described, in which a slip is shaped into a thin layer, this thin layer is applied to a plaster mold, dried layer by layer, and after application of all the required layers, the unfinished part is sintered.

It is the task of the invention to create a ceramic shell in anatomical shape for the production of a dental prosthesis and to indicate a method for the production of a ceramic shell for a dental prosthesis, which shell and method allow simple processing of the ceramic shell.

This task is accomplished by means of the characteristics of the independent claims 1 and 11. Further advantageous embodiments of the invention are the object of the dependent claims, in each instance. These can be combined with one another in technologically practical manner. The description, in particular in connection with the drawing, additionally characterizes and specifies the invention.

According to the invention, an anatomically pre-shaped ceramic shell for the production of a dental prosthesis, in particular for veneering of a dental framework or as a full ceramic dental prosthesis, is indicated, which shell is produced as a green compact from a ceramic powder and a binder system, and the ceramic shell can be adapted to a body as a whole, without loss of the characteristic anatomical shape, in particular in edge regions.

The starting basis is a ceramic usual in dentistry, such as, for example, an oxide ceramic, a silicate ceramic or a glass ceramic, as well as other technical ceramics that are adapted to the corresponding application purpose with regard to their heat expansion coefficient. The ceramics to be used are produced from a suitable glass frit, by means of powder technology, ground out, and processed in paste-like manner with a corresponding binder system, in a stirrer mechanism, to produce a slip. A particular feature of the ceramic shell according to the invention is therefore the administration form as a slip ceramic, so that a flexible ceramic is made available, which can still be plastically adapted to give it shape, before firing. Thereby it is possible to individually adjust the shape progression at the preparation boundary individually by means of bending and cutting, and this clearly simplifies processing. Accordingly, in the case of the ceramic shell according to the invention, the shaping process for forming the anatomical shape has already been completed, and therefore not only a saving in terms of time or costs but in particular, improved reproducibility and easier integration into a treatment sequence. In this regard, the ceramic shell can be adapted to a support or a framework without loss of the anatomical shape, so that slight adjustments are still possible even after shaping.

In this regard, the term “characteristic anatomical shape” is understood to mean that the ceramic shell already has its final shape except for the shrinkage that usually occurs during the sintering process. Compensation of sintering shrinkage can be taken into consideration by means of a suitable method, but this is not a part of the present invention. In this regard, it should particularly be noted that sintering shrinkage does not need to be linear in all cases, with regard to the three spatial axes.

According to one embodiment of the invention, the green compact is monochrome or polychrome.

Accordingly, it is possible to form plastically deformable monochrome or polychrome ceramic veneer shells, which are present as non-fired shaped bodies. In the case of polychrome ceramic shells, adaptation of the color of the dental prosthesis to be formed, for example in the dentin region, can take place in this regard.

According to a further development of the invention, the green compact can be connected with the dental framework or a refractory shaped body by means of a viscous ceramic filler compound, in particular a ceramic sol.

After shape-giving fitting to the veneer framework or another shaped body having a fixed shape, a viscous ceramic filler compound is injected behind the ceramic shell. In this regard, the filler compound can be made available as a ceramic sol having great viscosity. By pressing it against the veneer framework or the refractory shaped body, excess filler compound is pressed out, so that possible cavities or air inclusions are filled. In this regard, the filler compound serves as an equalization compound for undercuts, for example, or for equalization of gap dimensions between the ceramic shell and the framework. The filler compounds acts functionally here, so as to compensate undercuts and different gap dimensions, since these would bring about undesirable collapse locations on the anatomically shaped vestibular surface.

According to a further embodiment of the invention, UV initiators for light polymerization are added to the viscous ceramic filler mass.

As a result, it is possible to fix the ceramic shell, which has been adjusted in terms of shape, in place on a support or a framework, in the correct position, until first firing takes place.

According to a further embodiment of the invention, the ceramic filler compound has thixotropic properties.

In this regard, a conventional power ceramic/water mixture can be applied with a brush, for example, or a corresponding ceramic sol having thixotropic properties can be made available.

According to a further embodiment of the invention, the viscous ceramic filler compound brings about color adaptation.

Accordingly, the additional possibility exists of undertaking subsequent natural color adaptation of the ceramic shell and its basic color using a tooth-colored, chromatic dye.

According to another embodiment of the invention, the ceramic shell has the property of imparting tooth color.

Here, the ceramic shell is not only configured as a thin shell, as was already known in the state of the art, but rather represents a significant portion of the veneer, so that a tooth color can be established by way of the ceramic shell.

According to the invention, a method for the production of a ceramic shell for a dental prosthesis, in particular for a veneer of a dental framework or as a full ceramic dental prosthesis is indicated, which comprises the following steps. After a ceramic slip is made available, shaping of the ceramic slip to form a slip film takes place, along with possible pre-drying of the slip film for adjusting the degree of moisture and thereby the required viscosity. After the slip film is pressed into a film mold, for example, as a negative mold for forming a concave, flexible ceramic shell, removal of the flexible ceramic shell in the form of a green compact takes place.

Shaping of the ceramic slip can be carried out in such a manner, in this regard, that two slip films that lie next to one another or one on top of the other are formed, which films have different colors or different transparency, so that the slip film that is formed has monochrome or polychrome properties. The shaping processing of the ceramic slip is possible in different ways. For example, the ceramic slip can be produced by means of injection-molding or stamping, but application of the ceramic slip to a structured carrier film or silicone mold is also possible. Likewise, mixed forms of the shaping methods can be used so as to shape the ceramic slip accordingly.

In this regard, the wet slip film can pass through a drying zone so as to adjust the degree of moisture in such a manner that the slip film becomes paste-like and easy to shape. On the basis of the degree of moisture, the slip film can be created with the specific viscosity that is adapted to the desired further processing and use. Preferably by means of a structure roller that follows, the slip can be pressed into the film that has been stamped to provide the shape, as a negative mold, so as to achieve a slightly concave tooth shell shape of the ceramic shell. Typical layer thicknesses amount to 0.1 to 2 mm, wherein the different ceramic materials already mentioned above can be used with a suitable binder system.

In the following, some exemplary embodiments will be explained in greater detail using the drawing. This shows:

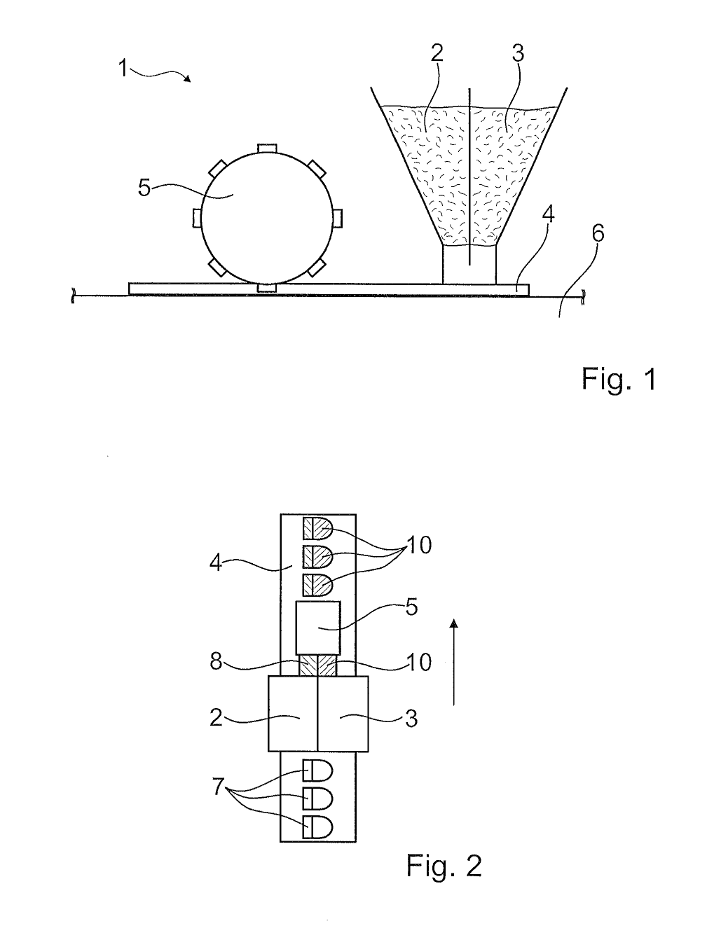

FIG. 1 an arrangement for the production of a ceramic shell according to the invention in a side view;

FIG. 2 the arrangement from FIG. 1 in a top view;

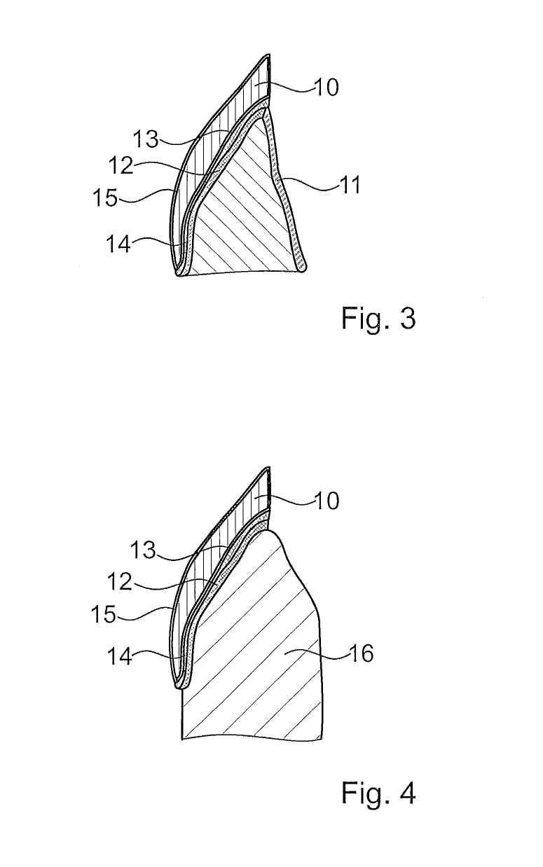

FIG. 3 a ceramic shell according to the invention together with a veneer framework; and

FIG. 4 a ceramic shell according to the invention together with a shaped body.

In the figures, the same or functionally equivalent components are provided with the same reference symbols.

Making reference to FIG. 1, an arrangement 1 will be described below, with which ceramic shells according to the invention can be produced. A suitable ceramic with a binder system as a watery or paste-like slip is applied to a structured carrier film 4 as a negative mold from a first slip funnel 2 and a second slip funnel 3, by way of broad-slit nozzles. The two slip funnels 2 and 3 are filled with ceramic slips of different colors, in this regard, which slips can bring about different coloring in the tooth enamel and dentin region, for example.

Application of the two ceramic slips can take place at the same time, next to one another or one on top of the other. Thereby two ceramic colorations are formed, which run into one another. In this regard, the slip film can pass through a drying zone, so as to adapt the degree of moisture in such a manner that the slip film becomes paste-like and easy to shape. The slip can be pressed into the shape-giving stamped film 4 by means of a subsequent structure roller 5. The film 4 can be applied on a conveyor belt 6 that circulates. Processing of the ceramic slip to produce ceramic shells, using the arrangement 1 according to FIG. 1, will be explained in greater detail once again below, making reference to FIG. 2. In this regard, FIG. 2 shows a top view of the structured carrier film 4 in the region of the slip funnels 2 and 3 and of the structure roller 5. It can be seen that the carrier film 4 has a stamped labial surface of front teeth as the structure, for example, which surfaces are provided with the reference symbol 7 in FIG. 2.

The slip funnels 2 and 3 dispense a first ceramic slip 8 and a second ceramic slip 9, which, as is shown in FIG. 2, are disposed to lie next to one another. In the region of the structure roller 5, the two ceramic slips 8 and 9 are formed into a slip film that forms the concave, flexible ceramic shell 10 by being pressed into the film mold. In this regard, the ceramic slip 8 or 9 can also be applied by means of injection molding or by means of stamping, or, as a shaping process, can be implemented by means of a ceramic slip in injection molds or injection stamping molds.

In another variant of the method according to the invention, the concave flexible shell 10 could also be produced by means of deep-drawing or by means of introduction into mold plates structured as films.

Use of the flexible ceramic shell 10 will be explained in greater detail below, making reference to FIG. 3. In FIG. 3, a veneer framework 11 is shown schematically, which has a corresponding convex veneer surface 12. The anatomically shaped ceramic shell 10 is set onto this convex veneer surface 12. The ceramic shell 10 has a concave contact surface 13, wherein a gap 14 is present between the concave contact surface 13 and the convex veneer surface 12.

The opposite side of the ceramic shell 10 represents the vestibular, anatomical tooth shape 15. The gap 14 between the convex veneer surface 12 of the veneer framework 11 and the concave contact surface 13 of the ceramic shell 10 is eliminated by means of a ceramic filler compound that is typically made available as a ceramic sol. The opposite contact surface 13 of the ceramic shell 10 represents the vestibular, anatomical tooth shape 15. The gap 14 between the concave contact surface 13 of the ceramic shell 10 and the convex veneer surface of the framework 11 is eliminated by means of a ceramic filler compound that is typically made available as a ceramic sol. In this regard, the viscous ceramic filler compound functions as an equalization compound, and can accordingly equalize different gap dimensions as well as undercuts between the ceramic shell 10 and the veneer framework 11.

The ceramic filler compound, i.e. the ceramic/glass sol, is supposed to equalize different gap dimensions or undercuts of the framework or of the shaped body as a refractory compound, so as to prevent collapse locations on the ceramic shell 10 and the anatomical outer surface 15 caused in this way. For this purpose, the viscous ceramic filler compound is injected behind the ceramic shell 10 after shaping fitting to the veneer framework 11, and the shell is pressed onto the veneer framework 11, so that excess filler compound is pressed out.

In yet another embodiment, the ceramic filler compound can also have a coloring property, so that the ceramic shell 10 can be adapted with regard to its basic color.

Because of the flexible property of the ceramic shell 10, the shape progression can thereby be individually adjusted, for example at the preparation boundary, by means of bending and cutting. However, it is important that by using the viscous ceramic filler compound, an uncontrolled shape change of the vestibular, anatomical tooth shape 15 due to collapse locations, triggered by undercuts of the underlying framework or of the carrier is prevented. An irregular gap 14 would be transferred to the vestibular anatomical tooth shape 15, so that the ceramic shell 10 used as a veneer shell would be attached to the veneer framework or the carrier with a changed outer shape.

An undesirable thermal change in shape caused by melting and shrinking is compensated, to the greatest possible extent, by means of the viscous ceramic filler compound. In this regard, it can also be provided that UV initiators for light polymerization are added to the filler compound, so that until the first firing step, the ceramic shell 10 is fixed in place on the veneer framework 11, with plastic shape adaptation and fixation of position, by way of the filler compound.

In FIG. 4, a second embodiment is shown. Here, in contrast to the embodiment according to FIG. 3 described above, the ceramic shell 10 is applied not to a veneer framework but rather to a refractory shaped body 16 as a carrier. However, further process management and attachment are identical.

Accordingly, the ceramic shell 10 can be used not only for forming a full ceramic dental prosthesis but also for placing a veneer on a dental framework.

After the first firing step, further firing steps for color correction and shape correction can also be carried out. The ceramic shell 10, produced as a film ceramic, is elastic and can therefore be individually adapted to the three-dimensional shape progression of the preparation boundary, by means of bending and cutting. It is fundamentally possible to add a suitable UV initiator for light polymerization to the ceramic sol, so as to fix the ceramic shell 10, which has been subsequently adapted to the framework or carrier in terms of its shape, in place until the first firing.

The remaining free surfaces of the framework can subsequently be conventionally provided with a veneer using a conventional powder ceramic/water mixture and a ceramic brush, or they can be completed using a thixotropic ceramic sol, to provide the desired tooth shape.

Since shrinkage of up to 16% can be assumed during the first main vacuum firing, the approximal regions and the incisal strip can be built up using suitable effect compounds, so as to compensate for this shrinkage within the scope of the first firing, together with the green compact.

Furthermore, use of the industrially produced flexible ceramic shell offers the significant advantage of the very homogeneous ceramic structure, which leads to uniform shrinkage. In contrast to this, manual anatomical layering demonstrates the significant disadvantage that here, a powder ceramic that is mixed with different viscosity and solid/water content, in portions, is used, and this then leads to differently great shrinkage and crack formation.

The goal here is to achieve a color-stable and shape-stable restoration with tape guidance (first main vacuum tape), and to conclude possible corrections in color and shape in the second firing as a combined color correction glass firing by means of LFC ceramics (LFC=low fusing ceramic <750° C.).

The characteristics indicated above, as well as the characteristics that can be derived from the figures, can be advantageously implemented both individually and in different combinations. The invention is not restricted to the exemplary embodiments described, but rather can be modified in many ways within the scope of the ability of a person skilled in the art.

1. An anatomically pre-shaped ceramic shell for the production of a dental prosthesis, in particular for veneering of a dental framework or as a full ceramic dental prosthesis, which shell is produced as a green compact from a ceramic powder and a binder system, and the ceramic shell can be adapted to a body as a whole without loss of the characteristic anatomical shape, in particular in edge regions.

2. The ceramic shell according to claim 1, in which the green compact is monochrome or polychrome.

3. The ceramic shell according to claim 1, in which the green compact can be used with the dental framework or a refractory shaped body, by means of a viscous ceramic filler compound, in particular a ceramic sol.

4. The ceramic shell according to claim 3, in which UV initiators for light polymerization are added to the viscous ceramic filler compound.

5. The ceramic shell according to claim 3, in which the viscous ceramic filler compound has thixotropic properties.

6. The ceramic shell according to claim 3, in which the viscous ceramic filler compound acts as an equalization compound.

7. The ceramic shell according to claim 3, in which the viscous ceramic filler compound brings about a color adjustment.

8. The ceramic shell according to claim 1, in which the binder system is a polymer binder, an organic binder or a binder on the basis of wax.

9. The ceramic shell according to claim 1, which has a layer thickness of 0.1 mm to 3 mm.

10. The ceramic shell according to claim 1, which has a tooth-coloring property.

11. A method for the production of a ceramic shell for a dental prosthesis, in particular for a veneer of a dental framework or as a full ceramic dental prosthesis, comprising the steps:
making a ceramic slip available;
preparing the ceramic slip to form a slip film;
possible pre-drying of the slip film for adjusting the degree of moisture or the viscosity;
forming a concave, flexible ceramic shell in an anatomical shape;
removing the flexible ceramic shell in the form of a green compact; and
adapting the flexible ceramic shell to a volume body or a surface body.

12. The method according to claim 11, in which the step of preparing the ceramic slip comprises forming at least two slip films that lie next to one another or one on top of the other, which films have different colors or different transparency.

13. The method according to claim 11, in which pressing the slip film into a negative mold takes place in order to form the concave ceramic shell.

14. The method according to claim 13, in which the negative mold as a carrier film is part of a circulating conveyor belt.

15. The method according to claim 13, in which pressing the slip film in and/or post-compressing the slip film takes place by means of a stamping roller.

16. The method according to claim 13, in which the negative mold transfers a vestibular tooth shape to the slip film.

17. The method according to claim 11, in which deep-drawing or introduction into mold plates takes place for forming the concave ceramic shell.

18. The method according to claim 11, in which the flexible ceramic shell is connected with a dental framework or a refractory shape or compound by means of a viscous ceramic filler compound, in particular a ceramic sol.
